(19) United States
(12) Patent Application Publication
(10) Pub. No.: US 2023/0261174 A1
(43) Pub. Date: Aug. 17, 2023

(54) A METHOD FOR PRODUCING A CARBON-SILICON COMPOSITE MATERIAL POWDER, AND A CARBON-SILICON COMPOSITE MATERIAL POWDER

(71) Applicant: Stora Enso OYJ, Helsinki (FI)

(72) Inventors: Vilhelm Olsson, Täby (SE); Mario Wachtler, Strängnäs (SE); Stephan Walter, Tyresö (SE); David Masson, Johanneshov (SE); Lena Lönnemark, Solna (SE)

(73) Assignee: Stora Enso OYJ, Helsinki (FI)

(21) Appl. No.: 18/003,939

(22) PCT Filed: Jul. 2, 2021
(86) PCT No.: PCT/IB2021/055941

§ 371 Date: Dec. 30, 2022

(30) Foreign Application Priority Data
Jul. 3, 2020 (SE) 2050837-0

(51) Int. Cl. H01M 4/36; H01M 4/583; H01M 4/38; H01M 4/04; H01M 4/62

(52) U.S. Cl. CPC H01M 4/364; H01M 4/386; H01M 4/0471; H01M 4/583; H01M 4/625; H01M 2004/021

(57) ABSTRACT

The present disclosure relates to a method for producing a carbon-silicon composite material powder, comprising: providing a carbon-containing precursor, which is lignin; providing at least one silicon-containing active material; melt-mixing at least said carbon-containing precursor and said silicon-containing active material(s) to a melt-mixture; providing said melt-mixture in a non-fibrous form and cooling the melt- mixture to provide an isotropic intermediate composite material; subjecting said isotropic intermediate composite material to a thermal treatment, wherein said thermal treatment comprises a carbonization step to provide a carbon-silicon composite material, and subjecting said carbon-silicon composite material to pulverization to provide said carbon-silicon composite material powder. The present disclosure also relates to a carbon-silicon composite material powder obtainable by the method, a negative electrode for a non-aqueous secondary battery, such as a lithium-ion battery, comprising the carbon-silicon composite material powder, and use of the carbon-silicon composite material powder in a negative electrode of a non-aqueous secondary battery.

### TECHNICAL FIELD

The present disclosure relates to a method for producing a carbon-silicon composite material powder, and a carbon-silicon composite material powder obtainable by the method. In addition, the present disclosure relates to a negative electrode for a non-aqueous secondary battery, such as a lithium-ion battery, comprising the carbon-silicon composite material powder obtainable by the method as active material. Also, the present disclosure relates to use of the carbon-silicon composite material powder obtainable by the method as active material in a negative electrode of a non-aqueous secondary battery, such as a lithium-ion battery.

### BACKGROUND

Secondary batteries, such as lithium-ion batteries, are electrical batteries which can be charged and discharged many times, i.e. they are rechargeable batteries. For example, lithium-ion batteries are today commonly used for portable electronic devices and electric vehicles. Lithium-ion batteries have high energy density, high operating voltage, low self-discharge and low maintenance requirements.

In lithium-ion batteries, lithium ions flow from the negative electrode through the electrolyte to the positive electrode during discharge, and back when charging. Today, typically a lithium compound, in particular a lithium metal oxide, is utilized as material of the positive electrode and a carbonaceous material is utilized as material of the negative electrode.

Graphite (natural or synthetic graphite) is today utilized as material of the negative electrode in most lithium-ion batteries. Graphite offers a theoretical capacity of 372 mAh/g (corresponding to a stoichiometry of LiC₆) at low potentials of 50 to 300 mV vs. Li/Li⁺, which translates into high energy densities on a cell level. Furthermore, it offers a stable charge/discharge performance over typically 1000 to several 1000 cycles.

An alternative to graphite is amorphous carbon materials, such as Hard Carbons (non-graphitizable amorphous carbons) and Soft Carbons (graphitizable amorphous carbons), which lack long-range graphitic order. Amorphous carbons can be used as sole active electrode materials or in mixtures with graphite (and/or other active materials).

Amorphous carbons can be derived from lignin. Lignin is an aromatic polymer, which is a major constituent in e.g. wood and one of the most abundant carbon sources on earth. In recent years, with development and commercialization of technologies to extract lignin in a highly purified, solid and particularized form from the pulp-making process, it has attracted significant attention as a possible renewable substitute to primarily aromatic chemical precursors currently sourced from the petrochemical industry. Amorphous carbons derived from lignin are typically non-graphitizable, i.e. Hard Carbons.

Hard Carbons typically show very good charge/discharge rate performance (higher than graphite) both at room temperature and low temperature, which is desired for high power systems, fast charging devices, low temperature applications, etc. The electrochemical charge/discharge of Hard Carbons occurs between ca. 1.3 V vs. Li/Li⁺ and <0 V vs. Li/Li⁺ and, when plotting the electrode potential over capacity, comprises a steadily sloping potential region above approx. 0.1 V vs. Li/Li⁺ and an extended potential plateau region below this value. The average electrode potential is higher than that of graphite. Due to their lower geometric density and higher average electrode potential they give a lower usable energy density on cell level than graphite.

Common to graphite and amorphous carbons is that the volume changes during charge (Li insertion) and discharge (Li de-insertion) are small (for graphite approx. 10 vol.%). This results in a good mechanical stability of the electrode material and electrode and helps to maintain good cycling stability.

Both graphite and amorphous carbons work at potential ranges outside the thermodynamic stability window of the electrolyte. During the first charge the electrolyte is decomposed, and parts of the decomposition products form a protective layer at the electrode surface, the so-called “solid electrolyte interphase” (SEI). The formation of the SEI irreversibly consumes charge, mostly during the first charge, resulting in irreversible capacity loss in the first (few) cycle(s) and lowering the initial Coulombic efficiency (ICE, or first cycle charge/discharge efficiency). Once the SEI is fully formed, electrolyte decomposition comes to an end and reversible cycling becomes possible.

Due to the small volume changes during cycling of graphite and amorphous carbons, the mechanical strain on the SEI is small, and a once fully formed SEI remains more or less stable, and the irreversible capacity loss due to SEI formation drops (next) to zero.

Yet another alternative negative electrode material is silicon. Elemental Si offers an ultra-high theoretical capacity of 3579 mAh/g (corresponding to the reaction: 4 Si + 15 Li⁺ + 15 e⁻ ↔ Li₁₅Si₄), and practical capacities close to this value. However, the use of pure Si is hampered by the enormous volume changes occurring during charge and discharge which are in the range of 260 vol.%, and which usually results in mechanical strain and cracking and disintegration of the electrode. This causes irreversible capacity loss (due to loss of cyclable Si), decreases the Coulombic efficiency (in the first and the following cycles), and shortens cycle life. This problem can be partially mitigated by using special binders (such as carboxymethylcellulose derivatives or polyacrylates), which form strong covalent bonds to the Si (and, after cracking, Si fragments).

Like graphite and amorphous carbon, Si works outside the stability window of the electrolyte, and a SEI is formed, producing irreversible capacity loss and decreasing the initial Coulombic efficiency. However, due to the enormous volume changes during charge and discharge, a once fully formed SEI may not be stable, but break, and may need to be repaired in the following cycles. This repair produces additional irreversible capacity loss and decreases the Coulombic efficiency also in the cycles following the first cycle. It has been shown, that this situation can be partially mitigated by using special electrolytes and electrolyte additives, such as fluoroethylene carbonate (FEC), which produce a SEI especially adapted to Si electrodes.

Some stabilization of Si electrodes can be achieved by using Si-rich compounds instead of pure elemental Si. Si-rich compounds comprise Si suboxide (SiOₓ, with 0 ≤ x ≤ 2), Si alloys (such as e.g. SiFeₓ, SiFeₓAl_{y}, or SiFeₓC_{y}), and other compounds which are rich in Si. One example is silicon suboxide SiOₓ. Different models have been proposed to describe the structure of SiOₓ. Most commonly SiOₓ is described as a mixture of Si and SiO₂ interdispersed on a nanometric scale.

It has been proposed that SiOₓ reacts in two steps. For simplicity the case for x=1 will be considered: First SiO reacts irreversibly according to the reaction 4 SiO + 4 Li⁺ + 4 e⁻ → Li₄SiO₄ + 3 Si, yielding an irreversible capacity loss of 608 mAh/g. In a second step, and during all subsequent charge and discharge cycles, the released Si reacts reversibly according to the reaction 4 Si + 15 Li⁺ + 15 e⁻ ↔ Li₁₅Si₄, yielding a reversible capacity of 1710 mAh/g. The theoretical initial Coulombic efficiency thus amounts to 73.8% and is thus lower than for elemental Si (with a theoretical initial Coulombic efficiency of 100%). Compared to pure elemental Si the Li uptake and hence the volume changes of SiOₓ are however significantly smaller, and hence the cycling stability improved. Similar considerations as for SiOₓ apply to other Si compounds, in which the reacting Si is diluted within a stabilizing matrix.

A common route to exploit the high capacity of Si or Si-rich compounds (herein commonly denoted as silicon-containing active materials or SiX), without sacrificing too much of the cycling stability, is to add small amounts of SiX to graphite electrodes. For instance, for every 1 wt-% of elemental Si added to graphite the reversible capacity increases by approximately 10%. Accordingly, the addition of Si or Si-rich compounds can be used to increase the reversible capacity of amorphous carbons.

Commercial composite materials of carbon and SiX, e.g. composite materials of graphite and SiX, are today typically produced by methods comprising any one of the following steps:
Mixing of graphite and SiX before electrode preparation, using for instance, high energy mixing or milling techniques
Coating of graphite with thin layers of a silicon-containing active material, e.g. by chemical vapor deposition (CVD), to obtain graphite/SiX core/shell materials
Coating of SiX particles with thin carbon layers, e.g. by wet-chemical methods, to obtain SiX/carbon core/shell materials
Blending of graphite with SiX during electrode preparation

The component of SiX in the methods mentioned above may be surface pre-oxidized or carbon coated to increase its stability. Furthermore, the composite of carbon and SiX material may be additionally carbon-coated to increase its stability.

When utilized as a material in an electrode of a secondary battery, the composite materials of graphite/carbon and SiX are commonly provided in powder form and mixed with a binder to form the electrode.

US 2014/0287315 A1 describes a process for producing an Si/C composite, which includes providing an active material containing silicon, providing lignin, bringing the active material into contact with a C precursor containing lignin and carbonizing the active material by converting lignin into carbon at a temperature of at least 400° C. in an inert gas atmosphere. The silicon-based active material can be subjected to milling together with lignin or be physically mixed with lignin.

However, in composite materials of graphite/carbon and SiX obtained by methods such as milling or coating, such as those mentioned above, the single components are typically present next to each other (SiX next to graphite/carbon), or on top of each other (SiX on top of the surface of graphite/carbon or graphite/carbon on top of the surface of SiX). Thus, the amount of SiX loading, while maintaining a good and uniform dispersion of Si, is limited. Furthermore, unless SiX or the composite of graphite/carbon and SiX are carbon coated, SiX will be in direct contact with the binder and the electrolyte of a secondary battery in which the composite is used as active material in a negative electrode, giving rise to all the problems with cycling stability and Coulombic efficiency mentioned above. Special binders and electrolytes are thereby required.

Thus, there is still room for improvements of methods for producing a carbon-silicon composite material powder.

### DESCRIPTION OF THE INVENTION

It is an object of the present invention to provide an improved method for producing a carbon-silicon composite material powder, which method allows use of a renewable carbon source, which method eliminates or alleviates at least some of the disadvantages of the prior art methods and which method provides an improved carbon-silicon composite material powder suitable for use as active material in the negative electrode of a secondary battery, such as a lithium-ion battery.

The above-mentioned object, as well as other objects as will be realized by the skilled person in light of the present disclosure, are achieved by the various aspects of the present disclosure.

According to a first aspect illustrated herein, there is provided a method for producing a carbon-silicon composite material powder comprising:
providing a carbon-containing precursor, wherein the carbon-containing precursor is lignin;
providing at least one silicon-containing active material;
melt-mixing at least two components to a melt-mixture, wherein said carbon-containing precursor constitutes one component and each silicon-containing active material constitutes one component, and wherein said melt-mixing is performed at a temperature between 120-250° C.;
providing said melt-mixture in a non-fibrous form and cooling said melt-mixture in said non-fibrous form so as to provide an isotropic intermediate composite material,
subjecting said isotropic intermediate composite material to a thermal treatment, wherein said thermal treatment comprises a carbonization step so as to provide a carbon-silicon composite material, and
subjecting said carbon-silicon composite material to pulverization so as to provide said carbon-silicon composite material powder.

The invention is based on the surprising realization that by mixing of lignin (carbon-containing precursor) and at least one silicon-containing active material by melt-mixing (i.e. using combined mechanical and thermal energy) at a temperature between 120-250° C. to provide a melt-mixture, a high loading of the silicon-containing active material(s) and a good or high dispersion degree of the silicon-containing active material(s) may be obtained. The melt-mixing of the method according to the first aspect allows incorporation of the silicon-containing active material(s) at a stage where the carbon of the carbon-containing precursor is still plastic or liquid (and before the state where it has been transformed into rigid carbon). The silicon-containing active material(s) can thus be dispersed finely and uniformly to a good or high degree both within the carbon and on the carbon surface (and not only next to the carbon or on the surface of the carbon as in prior art methods). Thereby, a high loading of the silicon-containing active material(s) while maintaining a good or high dispersion degree of the silicon-containing active material(s) may be obtained.

In addition, the dispersion of the silicon-containing active material(s) both within the carbon and on the surface of the carbon, which dispersion is uniform to a good or high degree, implies that the major part of the silicon-containing active material(s) is surrounded by carbon and thus not in direct contact with the electrolyte when utilized as an active material for a secondary battery, such as a lithium-ion battery. This attenuates problems related with electrolyte reduction at the surface of the silicon-containing active material(s) and the instability of the SEI formed on the silicon-containing active material(s) associated with the prior art materials. Also, when utilized as an active material for a secondary battery, such as a lithium-ion battery, the silicon-containing active material(s) expand and shrink during electrochemical charge and discharge, causing mechanical strain in the material. The surrounding carbon matrix helps to stabilize the expanding silicon-containing active material(s).

Furthermore, by providing the melt-mixture in a non-fibrous form and cooling the melt-mixture in the non-fibrous form so as to provide an isotropic intermediate composite material, subjecting the isotropic intermediate composite material to a thermal treatment, which comprises a carbonization step, so as to provide a carbon-silicon composite material, which thus is isotropic, and subjecting the carbon-silicon composite material to pulverization, a powder of a carbon-silicon composite material, which is isotropic, is obtained. Use of a powder of an isotropic carbon-silicon composite material as active material in the negative electrode of a secondary battery, such as a lithium-ion battery, is advantageous since the isotropic feature implies that it is possible to obtain more uniform properties of the active material, and thus the electrode, compared to use of an anisotropic material. For example, use of an isotropic carbon-silicon composite material as active material in the negative electrode of a secondary battery instead of an anisotropic material results in more uniform electrode volume change during charge/discharge.

Thus, by using the method according to the first aspect of the invention, it is possible to obtain an improved powder of a carbon-silicon composite material, which has a high loading and a high or good dispersion degree of the silicon-containing active material(s) and which is isotropic implying advantages when used as active material in the negative electrode of a secondary battery, such as a lithium-ion battery. In addition, a renewable source of carbon may be utilized since lignin is utilized as carbon-containing precursor.

The term “carbon-silicon composite” in phrases such as “carbon-silicon composite material” and “carbon-silicon composite material powder” refers herein to a composite comprising carbon and one or more silicon-containing active material(s), e.g. a composite comprising carbon and elemental silicon, a composite comprising carbon and one or more silicon-rich compounds, or a composite comprising carbon, elemental silicon and one or more silicon-rich compounds.

The term “carbon-containing precursor”, as used herein, refers to a carbon precursor material which is used as the carbon source for the carbon matrix material of the carbon-silicon composite material of the present disclosure. According to the present disclosure, the carbon-containing precursor is lignin.

The term “lignin”, as used herein, refers to any kind of lignin which may be used as the carbon source for making a carbonized carbon-silicon composite material, i.e. a conductive carbon-silicon composite material. Examples of said lignin are, but are not limited to, lignin obtained from vegetable raw material such as wood, e.g. softwood lignin, hardwood lignin, and lignin from annular plants. Also, lignin can be chemically synthesized.

Preferably, the lignin has been purified or isolated before being used in the process according to the present disclosure. The lignin may be isolated from black liquor and optionally be further purified before being used in the process according to the present disclosure. The purification is typically such that the purity of the lignin is at least 90%, preferably at least 95%. Thus, the lignin used according to the method of the present disclosure preferably contains less than 10%, more preferably less than 5%, impurities such as e.g. cellulose, ash, and/or moisture.

Preferably, the carbon-containing precursor contains less than 1% ash, more preferably less than 0.5% ash.

The lignin may be obtained through different fractionation methods such as an organosolv process or a Kraft process. For example, the lignin may be obtained by using the process disclosed in WO2006031175 or the process referred to as the LignoBoost process.

Preferably, the carbon-containing precursor used in the method of the first aspect of the present disclosure is Kraft lignin, i.e. lignin obtained through the Kraft process. Preferably, the Kraft lignin is obtained from hardwood or softwood, most preferably from softwood.

Preferably, the carbon-containing precursor utilized in the method of the first aspect is a dried material. Preferably, the carbon-containing precursor comprises less than 5% moisture. The carbon-containing precursor utilized in the method of the first aspect may be provided in particulate form, such as powder, preferably having an average particle size of 0.1 µm - 3 mm.

The term “silicon-containing active material” (SiX), as used herein, refers to a material containing silicon which can be used as a (battery) capacity enhancing material in carbon-silicon composite materials and thus may be used for making a carbonized carbon-silicon composite material, i.e. a conductive carbon-silicon composite material.

The term “silicon-containing active material” (SiX), as used herein, encompasses both pure elemental Si and Si-rich compounds. Si-rich compounds comprise Si suboxide (SiOₓ, with 0 ≤ x ≤ 2), Si alloys (such as e.g. SiFeₓ, SiFeₓAl_{y}, or SiFeₓC_{y}), and other compounds which are rich in Si. Different models have been proposed to describe the structure of SiOₓ. Most commonly SiOₓ is described as a mixture of Si and SiO₂ interdispersed on a nanometric scale The silicon-containing active material (SiX) mentioned above may be provided in crystalline or amorphous form and may, in addition, be surface pre-oxidized or carbon coated to increase stability.

Thus, in some embodiments each silicon-containing active material utilized in the first aspect of the method is selected from the group of: elemental silicon, a silicon suboxide, a silicon-metal alloy or a silicon-metal carbon alloy. The silicon suboxide may be SiOₓ with 0 ≤ x ≤ 2. The silicon-metal alloy may be any suitable silicon-metal alloy, such as e.g. SiFeₓ or SiFeₓAl_{y}. The silicon-metal carbon alloy may be e.g. SiFeₓC_{y}.

In some embodiments, one silicon-containing active material is utilized, i.e. the step of providing at least one silicon-containing active material comprises providing one silicon-containing active material. In some of these embodiments, the silicon-containing active material is elemental silicon. In some of these embodiments, the silicon-containing active material is a silicon suboxide SiOₓ with 0 ≤ x ≤ 2. In some these embodiments, the silicon-containing active material is a silicon-metal alloy, such as e.g. SiFeₓ or SiFeₓAl_{y}. In some of these embodiments, the silicon-containing active material is a silicon-metal carbon alloy, such as e.g. SiFeₓC_{y}.

In some embodiments, more than one silicon-containing active material is utilized, i.e. the step of providing at least one silicon-containing active material comprises providing two, three, four or more silicon-containing active materials. Each silicon-containing active material constitutes then a component to be melt-mixed in the melt-mixing step. Each silicon-containing active material may then be selected from the silicon-containing active materials mentioned above. In one example, elemental silicon and a silicon suboxide are provided as silicon-containing active materials. In another example, two different silicon suboxides are provided as silicon-containing active materials. In a further example, uncoated and coated elemental silicon are provided as silicon-containing active materials. In yet a further example, carbon-coated elemental silicon and silicon suboxide are provided as silicon-containing active materials.

The silicon-containing active material is preferably provided in particulate form, preferably of microsize or nanosize. By “particulate form of microsize” is herein meant that the silicon-containing active material is in particulate form, with particles having an average particle size in the micrometer range, such as e.g. 1-50 µm. By “particulate form of nanosize” is herein meant that the silicon-containing active material is in particulate form, with particles having an average particle size in the nanometer range, such as e.g. 1-999 nm.

Typically, the average particle size of the silicon-containing active material in particulate form may be between 5 nm and 5 µm.

The silicon-containing active material in particulate form may be at least partly oxidized or carbon-coated prior to the melt-mixing, i.e. prior to the addition to the carbon-containing precursor. Also, the silicon-containing active material may be provided in crystalline or amorphous form.

In some embodiments, the carbon-containing precursor is mixed with 0.5-30 wt-%, or 1-15 wt-%, or 2-10 wt-%, of the at least one silicon-containing active material in the melt-mixing step. Thus, in these embodiments in total 0.5-30 wt-%, or 1-15 wt-%, or 2-10 wt-%, silicon-containing active material(s) are mixed with the carbon-containing precursor in the melt-mixing step.

As mentioned above, the step of melt-mixing of the method of the first aspect comprises melt-mixing at least two components to a melt-mixture, wherein the carbon-containing precursor constitutes one component and each silicon-containing active material constitutes one component. Thus, the step of melt-mixing may comprise melt-mixing the carbon-containing precursor and the silicon-containing active material(s) only. However, alternatively the step of melt-mixing may comprise melt-mixing the carbon-containing precursor, the silicon-containing active material(s) and one or more further components. The further components may be constituted by, for example, one or more dispersing additives. No solvent is utilized in the melt-mixing step.

In some embodiments, the method according to the first aspect further comprises a step of providing at least one dispersing additive, wherein the components melt-mixed in the melt-mixing step include said at least one dispersing additive. Thus, in these embodiments, the melt-mixing step comprises melt-mixing at least the carbon-containing precursor, the silicon-containing active material(s) and the at least one dispersing additive.

The dispersing additive(s) may be selected from the group of: monoethers, polyethers, mono-alcohols, polyalcohols, amines, polyamines, carbonates, polycarbonates, monoesters, polyesters and polyether fatty acid esters. For example, the dispersing additive(s) may be selected from the group of: polyethylene oxide (PEO) and branched polyether fatty acid esters (such as TWEEN, e.g. TWEEN 80).

In some embodiments, one dispersing additive is provided and melt-mixed with the other components in the melt-mixing step, wherein the dispersing additive is PEO. In some embodiments, one dispersing additive is provided and melt-mixed with the other components in the melt-mixing step, wherein the dispersing additive is a branched polyether fatty acid ester (such as TWEEN, e.g. TWEEN 80).

In some embodiments, the carbon-containing precursor is mixed with 0.5-30 wt-%, or 1-15 wt-%, or 2-10 wt-%, of the at least one silicon-containing active material and 0.5-10 wt-%, or 1-7 wt-%, of the at least one dispersing additive in the melt-mixing step. Thus, in these embodiments in total 0.5-30 wt-%, or 1-15 wt-%, or 2-10 wt-%, silicon-containing active material(s) and in total 0.5-10 wt-%, or 1-7 wt-%, dispersing additive(s) are mixed with the carbon-containing precursor in the melt-mixing step. However, the amount of dispersing additive(s) depends on the type(s) of utilized dispersing additive(s).

As mentioned above, the step of melt-mixing of the method of the first aspect is performed at a temperature between 120-250° C., such as at a temperature between 150-200° C. Preferably, the melt-mixing is performed in 1-60 minutes, such as 1-30 minutes or 1-25 minutes.

As mentioned above, the melt-mixing of lignin (carbon-containing precursor) and silicon-containing active material(s) at a temperature between 120-250° C. implies that a high loading of the silicon-containing active material(s) and a good or high dispersion degree of the silicon-containing active material(s) may be obtained. The melt-mixing of the method according to the first aspect allows incorporation of the silicon-containing active material(s) at a stage where the carbon of the carbon-containing precursor is still plastic or liquid (and before the state where it has been transformed into rigid carbon). The silicon-containing active material(s) can thus be dispersed finely and uniformly to a good or high degree both within the carbon and on the surface of the carbon (and not only next to the carbon or on the surface of the carbon as in prior art methods). Accordingly, the method according to the first aspect results in that the carbon of the carbon-containing precursor comprises embedded silicon-containing active material(s) and silicon-containing active material(s) covering a certain percentage of the surface.

By also including at least one dispersing additive as mentioned above in the melt-mixing of the method of the first aspect, it was surprisingly found that the dispersion degree of the silicon-containing active material(s) in the carbon of the carbon-containing precursor is further improved. Thus, it is thereby possible to obtain a powder of a carbon-silicon composite material, in which the uniform dispersion of the silicon-containing active material(s) is further improved and which is isotropic implying advantages when used as active material in the negative electrode of a secondary battery, such as a lithium-ion battery.

Furthermore, depending on the selection of the dispersing additive(s), use of the dispersing additive(s) may also imply that i.a. the melt viscosity can be kept low and that the melt can be kept stable, thus improving the processability. For example, the dispersing additives PEO, and TWEEN, such as e.g. TWEEN 80, provide such further properties being advantageous for the processability.

The step of melt-mixing of the method of the first aspect allows also incorporation of further composite components in addition to the silicon-containing active material(s). Thus, in some embodiments, one or more further composite component constitute(s) component(s) to be melt-mixed in the melt-mixing step, i.e. one or more further composite component is/are melt-mixed together with the carbon-containing precursor and the silicon-containing active material(s) and optional other components such as dispersing additive(s) in the melt-mixing step. For example, the further composite components may be graphite particles, carbon particles, Sn or Sn compounds, convertible oxides MO_{X} or sulfides MSx (where M is a metal which can reversibly react with Li) and any other material which reacts with Li and contributes to the Li storage capacity of the carbon-silicon composite material or which does not react with Li and helps to stabilize the other components in the carbon-silicon composite material.

Accordingly, in some embodiments the method further comprises a step of providing graphite and/or carbon particles, wherein the components melt-mixed in the melt-mixing step include said graphite and/or carbon particles.

The melt-mixing step of the method of the first aspect may be performed by any suitable device. For example, the melt-mixing step may be performed by kneading, compounding or extrusion. Thus, the melt-mixing step may, for example, be performed in a kneader, compounder or extruder. The melt-mixing inherently implies that the melted material of the produced melt-mixture is isotropic.

After the melt-mixing in the method of the first aspect, as mentioned above, the melt-mixture is provided in a non-fibrous form and cooled in the non-fibrous form so as to provide an isotropic intermediate composite material. Preferably, the melt-mixture is cooled to the ambient temperature, such as e.g. the room temperature. Thus, after finished melt-mixing and cooling, an isotropic intermediate composite material is provided.

The melt-mixture may be provided in the non-fibrous form in the melt-mixing device or outside the melt-mixing device after finished melt-mixing and cooled in the non-fibrous form to provide the isotropic intermediate composite material. For example, the melt-mixture may be provided as a mass or lump in or outside the melt-mixing device, which mass or lump does not have a fibrous form, where after the mass or lump is cooled in the non-fibrous form so as to provide a mass or lump of the isotropic intermediate composite material. Thus, if for example an extruder is utilized as melt-mixing device, the melt-mixture is extruded in a non-fibrous form to yield an isotropic material and the extruded melt-mixture is cooled to ambient temperature in the non-fibrous form to provide the isotropic intermediate composite material. In another example, a kneader is utilized as melt-mixing device, whereby the melt-mixture is provided as a mass or lump in the kneader after finished melt-mixing and cooled to ambient temperature to provide the isotropic intermediate composite material.

By providing the melt-mixture in a non-fibrous form after finished melt-mixing and by cooling the melt-mixture in the non-fibrous form, the isotropic feature of the melted material of the melt-mixture is kept, i.e. the produced intermediate composite material is isotropic.

The term “non-fibrous form” as used herein refers to a form which does not have the shape of a fiber, thread, yarn, filament, strand or any other elongate form.

The term “isotropic” as used herein for material specification, for example in phrases such as “isotropic intermediate composite material” and “isotropic carbon-silicon composite material”, denotes that the material has isotropic features, i.e. at least essential uniformity in all directions, at least on a microscopic level (i.e. on the micrometer scale). With “at least essential uniformity in all directions” is meant that there is at least essentially uniform structure (crystallographic order on an atom scale), texture (arrangement of pores within a particle made up of crystallites) and morphology (outer shape of a particle which may be made up of crystallites and pores) of C/Si composite material particles or intermediate C/Si composite material particles in all directions, no preferred morphological and structural orientation of SiX within the carbon matrix.

In some embodiments, the method of the first aspect comprises further a step of pre-mixing at least two of the components before the melt-mixing step. Thus, in the pre-mixing step at least two of the components that are to be melt-mixed in the melt-mixing step are pre-mixed. Further components may then be added in the melt-mixing step.

In embodiments comprising the pre-mixing step, the carbon-containing precursor and the at least one silicon-containing active material may be pre-mixed in the pre-mixing step. In embodiments comprising use of more than one silicon-containing active material, one or more silicon-containing active material(s) may be premixed with the carbon-containing precursor while one or more further silicon-containing active material(s) may be added in the melt-mixing step. If one or more dispersing additives are to be melt-mixed with the carbon-containing precursor and the silicon-containing active material(s), one or more dispersing additive may also be included in the pre-mixing step, e.g. be pre-mixed with the carbon-containing precursor and the silicon-containing active material(s), and/or be added in the melt-mixing step. In one alternative, one or more dispersing additives may be pre-mixed with the carbon-containing precursor while the silicon-containing active material(s) are added in the melt-mixing step. In another alternative, one or more dispersing additives may be pre-mixed with the silicon-containing active material(s), while the carbon-containing precursor is added in the melt-mixing step.

For example, the pre-mixing may be performed by dry mixing (i.e. without solvent), dry milling, wet milling, melt-mixing, solution mixing, spray-coating, spray-drying and/or dispersion mixing. Preferably, the pre-mixing is performed by dry mixing. The pre-mixing may be performed in one or more sub-steps.

As mentioned above, the obtained isotropic intermediate composite material is subjected to a thermal treatment, wherein the thermal treatment comprises a carbonization step (i.e. a step of carbonization) so as to provide a carbon-silicon composite material.

The carbonization of the carbonization step is performed so as to increase the carbon content of the composite material and may be performed at carbonization temperatures in the range of 700-1300° C., preferably 900-1200° C. The carbonization step may comprise a temperature ramp from a starting temperature, such as the ambient temperature, to a target carbonization temperature within the range of 700-1300° C., preferably 900-1200° C. The duration (dwell time) at the target carbonization temperature may be from 1 to 180 minutes, preferably from 1 to 120 minutes and most preferred from 30 to 90 minutes. For example, the heating rate in a batch-process may be 1-100° C./min. When running the process in continuous mode, the heating rates could be even higher approaching instant injection hot zones. Alternatively, the carbonization may be performed in one or more temperature sub-steps using various heating rates and intermediate temperatures before reaching a target carbonization temperature within the range of 700-1300° C., preferably 900-1200° C.

The carbonization is performed in an inert gas, such as e.g. nitrogen or argon, or an inert gas mixture, under ambient pressure or increased or reduced pressure. Alternatively, the carbonization is performed under vacuum. The carbonization may be performed in a batch process or continuous process. Any suitable reactor may be utilized for the carbonization step.

In some embodiments, the thermal treatment of the method of the first aspect consists of the carbonization step.

In some embodiments, the thermal treatment of the method of the first aspect comprises the carbonization step described above and further one or more initial heating steps before the carbonization step. Each initial heating step is performed so as to pre-carbonize the composite material, i.a. to get rid of volatiles, and may be performed as a batch process or continuous process. Each initial heating step may be performed at temperatures in the range of 250-700° C., preferably 400-600° C. Each initial heating step may comprise a temperature ramp from a starting temperature, such as the ambient temperature, to a target initial heating temperature within the range of 250-700° C., preferably 400-600° C. The duration (dwell time) at the target initial heating temperature may be from 1 to 180 minutes, preferably from 3 to 120 minutes. For example, the heating rate of the temperature ramp may be 1-100° C./min. Alternatively, the initial heating of each initial heating step may be performed in one or more temperature sub-steps using various heating rates and intermediate temperatures in order to reach a target initial heating temperature within the range of 250-700° C., preferably 400-600° C. Still alternatively, if two or more initial heating steps are included, one or more of the initial heating steps may comprise a temperature ramp to a target initial heating temperature as described above and one or more of the initial heating steps may comprise one or more temperature sub-steps as described above. The initial heating may be performed in the same type of reactors and inert gas or inert gas mixtures or under vacuum as described above for the carbonization.

As mentioned above, the carbon-silicon composite material provided by the carbonization of the thermal treatment of the method of the first aspect is subjected to pulverization so as to provide a carbon-silicon composite material powder. The pulverization may be performed by any suitable process, using for example a cutting mill, blade mixer, ball-mill, hammer mill and/or jet-mill. Optionally, fine/coarse particle selection by classification and/or sieving may be performed subsequent to the pulverization.

The pulverization of the carbon-silicon composite material and optional fine/coarse particle selection may be performed so as to obtain a carbon-silicon composite material powder comprising powder particles having an average particle size between 5-25 µm, as measured, for instance, by laser diffraction.

The method of the first aspect may comprise one or more further crushing steps or pulverization steps in addition to the step of pulverization of the carbon-silicon composite material. As mentioned above, the thermal treatment may in addition to the carbonization step also comprise one or more initial heating steps. The method of the first aspect may comprise one or more further crushing steps or pulverization steps after the one or more initial heating steps, but before the carbonization step, or may comprise one or more further crushing steps or pulverization steps between any initial heating steps.

In some embodiments, the method of the first aspect comprises a step of crushing or a step of pulverization of said isotropic intermediate composite material before said thermal treatment. Thus, in these embodiments, the isotropic intermediate composite material is in a pulverized or crushed form when the thermal treatment is started.

In some embodiments, the thermal treatment of the method of the first aspect comprises at least one initial heating step and a carbonization step, wherein a crushing or pulverization step is performed between the initial heating step(s) and the carbonization step. Thus, the carbonization is then performed of pre-carbonized intermediate carbon-silicon composite material in powder form or crushed form. Thus, in these embodiments the carbon-silicon composite material is in powder form or crushed form after finished thermal treatment and is then subjected to a further pulverization step (i.e. the above-mentioned pulverization step) so as to provide the carbon-silicon composite material powder. Optionally, these embodiments may also include a step of crushing or a step of pulverization of said isotropic intermediate composite material before said thermal treatment. Then the isotropic intermediate composite material is in powder form or crushed form when the thermal treatment is started too.

Optionally, fine/coarse particle selection by classification and/or sieving may be performed subsequent to any crushing step or pulverization step.

The carbon-silicon composite material powder obtained by the step of pulverization of the carbon-silicon composite material may undergo further processing, such as e.g. carbon-coating by chemical vapor deposition (CVD), pitch coating, thermal and/or chemical purification, heat treatment, particle size adjustment, and blending with other electrode materials to e.g. further improve its electrochemical performance.

In some embodiments, the carbon-silicon composite material powder comprises powder particles, wherein the method of the first aspect further comprises a step of carbon-coating the carbon-silicon composite material powder particles, preferably by means of chemical vapor deposition.

According to a second aspect illustrated herein, there is provided a carbon-silicon composite material powder obtainable by the method according to the first aspect. The carbon-silicon composite material powder according to the second aspect may be further defined as set out above with reference to the first aspect.

The carbon-silicon composite material powder obtained by the method according to the first aspect is preferably used as an active material in a negative electrode of a non-aqueous secondary battery, such as a lithium-ion battery. When used for producing such a negative electrode, any suitable method to form such a negative electrode may be utilized. In the formation of the negative electrode, the carbon-silicon composite material powder may be processed together with further components. Such further components may include, for example, one or more binders to form the carbon-silicon composite material powder into an electrode, conductive materials, such as carbon black, carbon nanotubes or metal powders, and/or further Li storage materials, such as graphite or lithium. For example, the binders may be selected from, but are not limited to, poly(vinylidene fluoride), poly(tetrafluoroethylene), carboxymethylcellulose, natural butadiene rubber, synthetic butadiene rubber, polyacrylate, poly(acrylic acid), alginate, etc., or from combinations thereof. Optionally, a solvent such as e.g. 1-methyl-2-pyrrolidone, 1-ethyl-2-pyrrolidone, water, or acetone is utilized during the processing.

According to a third aspect illustrated herein, there is provided a negative electrode for a non-aqueous secondary battery, such as a lithium-ion battery, comprising the carbon-silicon composite material powder obtainable by the method according to the first aspect as active material. The carbon-silicon composite material powder of the negative electrode according to the third aspect may be further defined as set out above with reference to the first aspect.

According to a fourth aspect illustrated herein, there is provided use of the carbon-silicon composite material powder obtainable by the method according to the first aspect as active material in a negative electrode of a non-aqueous secondary battery, such as a lithium-ion battery. The carbon-silicon composite material powder of the fourth aspect may be further defined as set out above with reference to the first aspect.

Secondary batteries, such as lithium-ion batteries, are electrical batteries which can be charged and discharged many times, i.e. they are rechargeable batteries. For example, lithium-ion batteries are today commonly used for portable electronic devices and electric vehicles. Lithium-ion batteries have high energy density, high operating voltage, low self-discharge and low maintenance requirements.

### BRIEF DESCRIPTION OF THE DRAWINGS

FIGS. 1a-c are SEM (1a) and SEM-EDX (1b, carbon only), (1c, silicon only) images of a HC/Si composite material powder obtained by initial ball-milling of lignin and silicon as described in Example 2.

FIGS. 2a-c are SEM (2a) and SEM-EDX (2b, carbon only), (2c, silicon only) images, respectively, of a HC/Si composite material powder with <13 wt-% Si obtained by melt-mixing without dispersing additive as described in Example 3.

FIGS. 3a-g are SEM (3a-b) and SEM-EDX (3c, carbon only), (3d, silicon only) images and cross-section SEM (3e) and SEM-EDX (3f, carbon only), (3 g, silicon only) images of a HC/Si composite material powder with <13 wt-% Si obtained by melt-mixing with PEO (dispersing additive) as described in Example 4. The elliptical structure / particle on the left side in FIGS. 3e to 3g is not part of the HC/Si sample, but is an artefact from sample preparation, namely the epoxy resin used to fix the HC/Si sample for the cross-sections.

FIGS. 4a-c are SEM (4a) and SEM-EDX (4b, carbon only), (4c, silicon only) images, respectively, of a pre-carbonized intermediate C/Si composite material powder obtained by melt-mixing with TWEEN 80 (dispersing additive) as described in Example 7.

FIGS. 5a-c are SEM (5a) and SEM-EDX (5b, carbon only), (5c, silicon only) images, respectively, of a pre-carbonized intermediate C/Si composite material powder obtained by melt-mixing with TWEEN 80 (dispersing additive) as described in Example 8.

FIG. 6 shows the electrochemical behavior of a HC/Si composite material powder obtained by melt-mixing as described in Example 9.

### EXAMPLES

### Example 1: Pure Hard Carbon (HC) (Comparative)

Softwood Kraft lignin was heat-treated in N₂ at 500° C. under N₂ flow using a heating rate of 10° C./min, and a dwell time at 500° C. of 1 hour (initial heating). After cooling to room temperature the obtained cake was crushed. The crushed material was heat-treated at 1000° C. under N₂ using a heating rate of 10° C./min, and a dwell time at 1000° C. of 1 hour (carbonization). After cooling, the carbonised material was milled and classified using a laboratory fluidised bed opposed jet mill and a single-wheel classifier to obtain a carbon powder with an average particle size of 10 µm as measured by laser diffraction.

### Example 2: HC/Si Composite Material Powder, Obtained by Ball-Milling (Comparative)

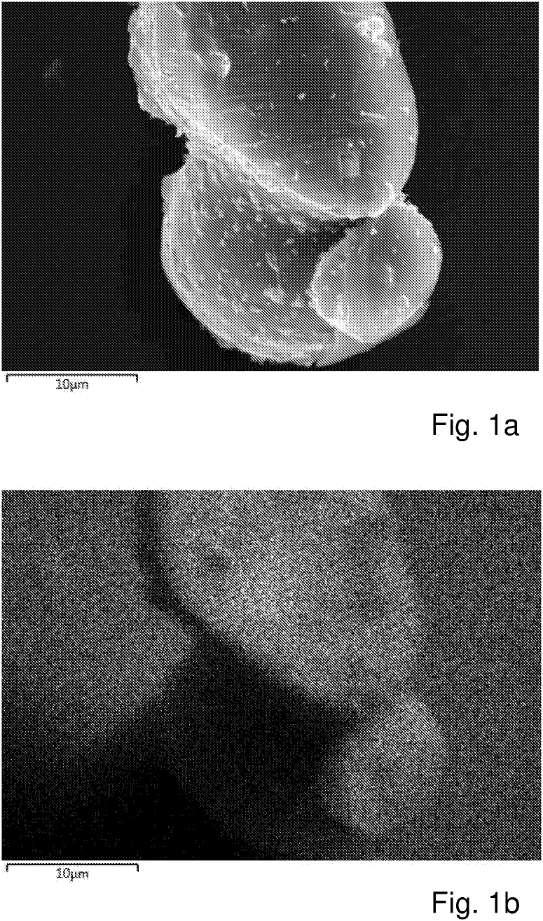

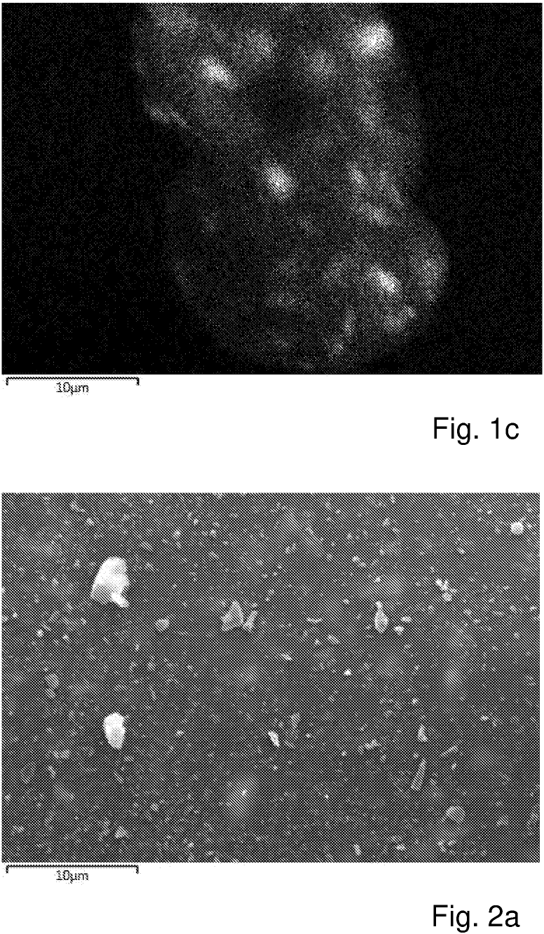

Softwood Kraft lignin was mixed with Si particles (with a primary particle size of 200 nm) using a laboratory mixer. The mixture was then transferred to a ball-mill and milled at 20 Hz for 3 minutes. The resulting lignin/Si mixture was then heat-treated, milled and classified in the same way as the material in Example 1, yielding a HC/Si composite material powder with an average particle size of 10 µm. FIGS. 1a-c are SEM (1a) and SEM-EDX (1b, carbon only), (1c, silicon only) images of the obtained HC/Si composite material powder.

### Example 3: HC/Si Composite Material Powder With <13 Wt-% Si, Obtained by Melt-Mixing Without Dispersing Additive

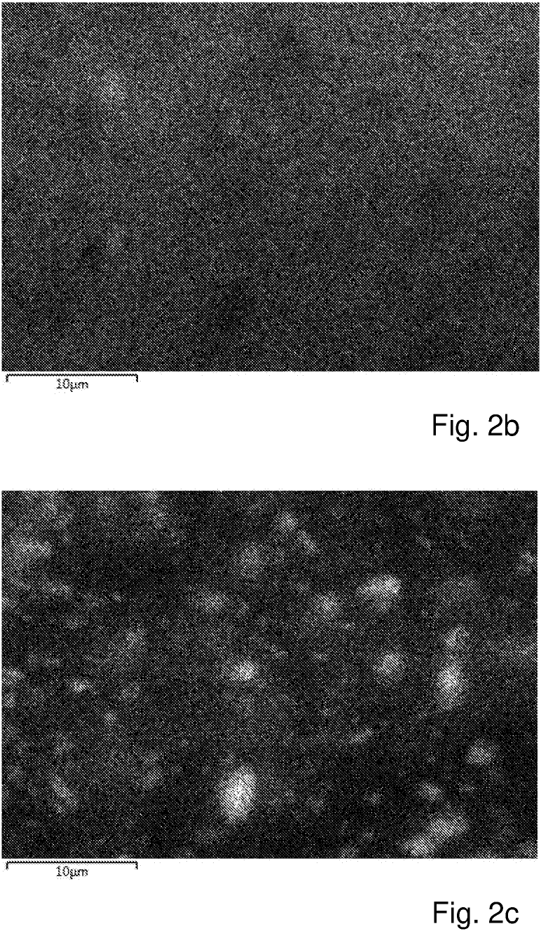

Softwood Kraft lignin was pre-mixed (dry mixed) with 5 wt-% Si particles (with a primary particle size of 200 nm) using a laboratory mixer. The mixture was then melt-mixed using a kneader (HAAKE™ Rheomix OS Lab Mixer equipped with banbury rotors) at a set temperature of 160 ºC for 20 minutes. After cooling to room temperature, a mass of a melt-mixed material (i.e. isotropic intermediate composite material) was obtained in the kneader. The material was then crushed, using a cutting-mill (equipped with a 0.5 mm cut-off sieve). The resulting lignin/Si mixture was then heat-treated, milled and classified according to Example 1, yielding a HC/Si composite material powder with <13 wt-% Si and with an average particle size of 10 µm. FIGS. 2a-c are SEM (2a) and SEM-EDX (2b, carbon only), (2c, silicon only) images, respectively, of the obtained HC/Si composite material powder. It is evident from the SEM-picture (2a), that a high loading of silicon and a high degree of silicon dispersion is obtained.

### Example 4: HC/Si Composite Material Powder With <13 Wt-% Si, Obtained by Melt-Mixing With PEO

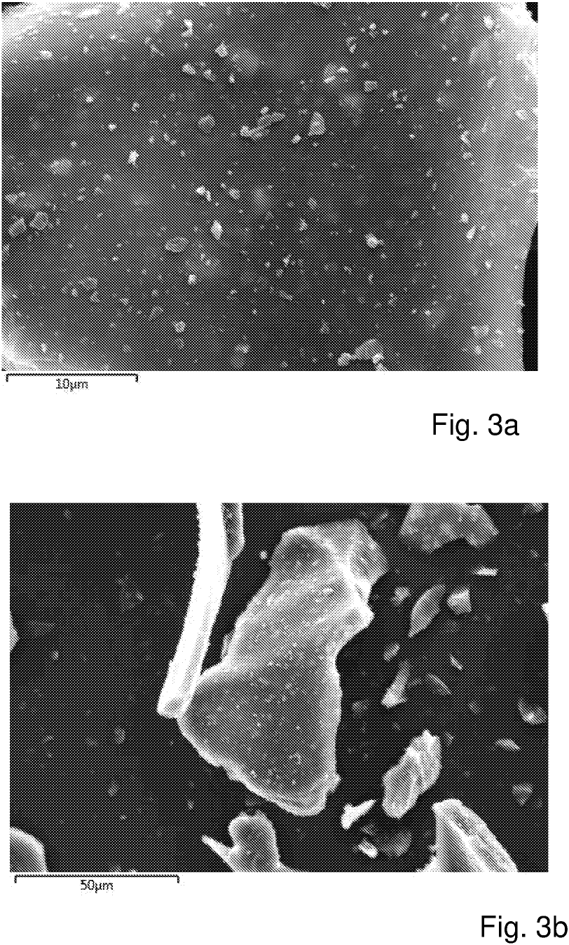

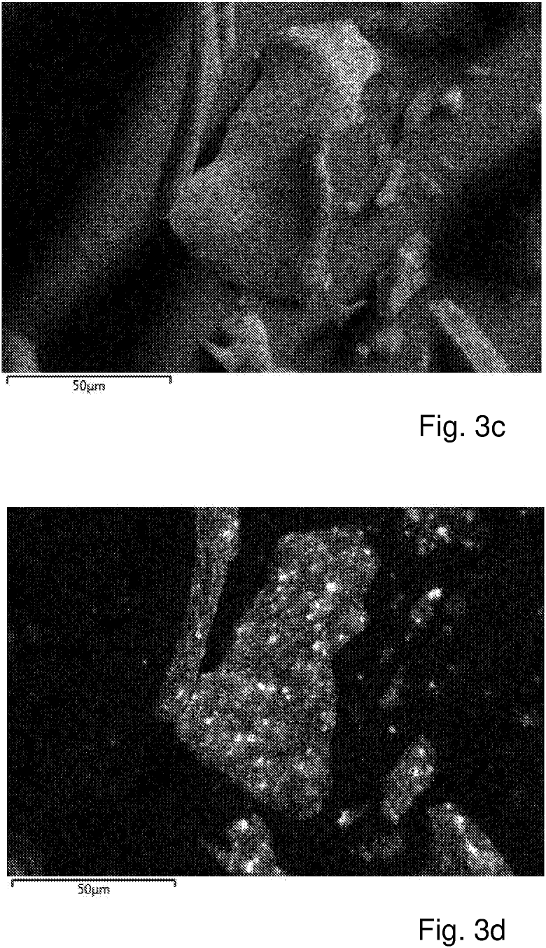

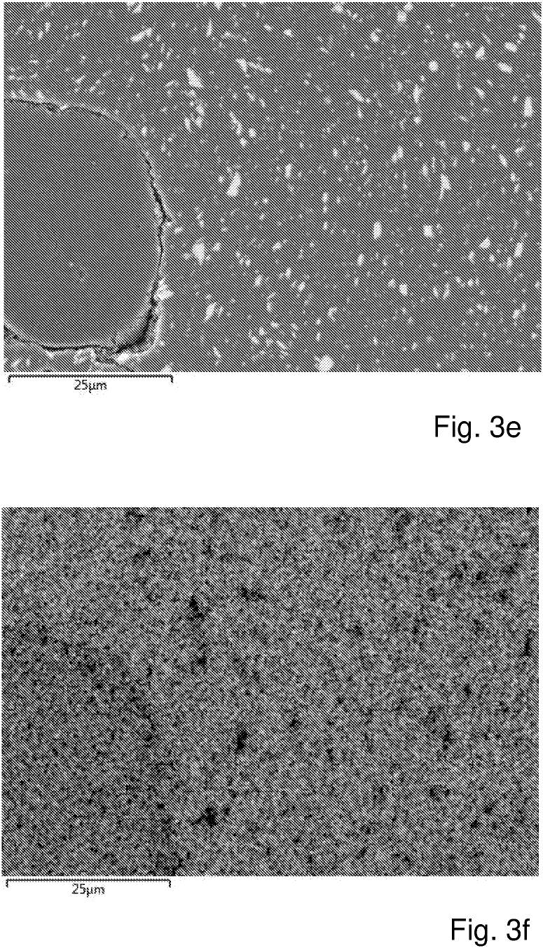

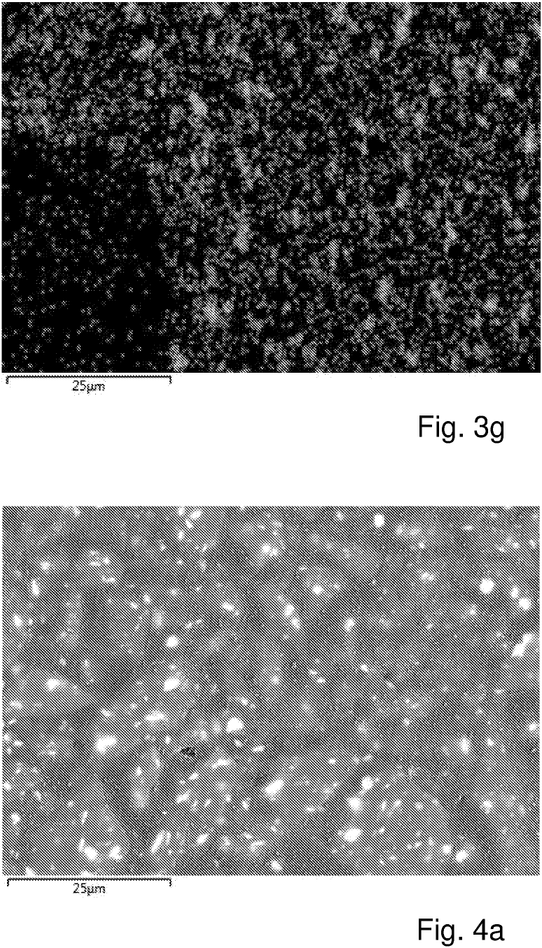

Softwood Kraft lignin was pre-mixed (dry mixed) together with 5 wt-% Si particles (primary particle size of 200 nm) and 5 wt-% of PEO (Mw=1500 g/mol) using a laboratory mixer. The mixture was then melt-mixed using a kneader (HAAKE™ Rheomix OS Lab Mixer equipped with banbury rotors) at a set temperature of 160 ºC for 20 minutes. After cooling to room temperature, a mass of a melt-mixed material (i.e. isotropic intermediate composite material) was obtained in the kneader. The material was then crushed using a cutting-mill (equipped with a 0.5 mm coarse cut-off sieve). The resulting lignin/Si mixture was then heat-treated, milled and classified in the same way as the material in Example 1, yielding a HC/Si composite material powder with <13 wt-% Si and with an average particle size of 10 µm. FIGS. 3a-g are SEM (3a-b) and SEM-EDX (3c, carbon only), (3d, silicon only) images of the obtained HC/Si composite material powder and cross-section SEM (3e) and SEM-EDX (3f, carbon only), (3 g, silicon only) images of the obtained HC/Si composite material powder. Note that the elliptical structure / particle on the left side in FIGS. 3e to 3g is not part of the HC/Si sample, but is an artefact from sample preparation, namely the epoxy resin used to fix the HC/Si sample for the cross-sections. It is evident from both SEM/SEM-EDX that a high loading of silicon in the matrix is obtained and that silicon is highly uniformly distributed on the surface as well as internally as by cross-section pictures. Also, it is evident from the SEM images of FIGS. 3a-g when compared with the SEM images of FIGS. 2a-2c that the use of a dispersing additive (PEO) results in further improvement of the degree of dispersion of silicon in the carbon matrix.

### Example 5: HC/Si Composite Material Powder With 2.0 Wt-% Si, Obtained by Melt-Mixing with PEO

Softwood Kraft lignin was pre-mixed (dry mixed) with 0.9 wt.% Si particles (with a primary particle size of 200 nm) and 5 wt-% of PEO (Mw=1500 g/mol) using a laboratory mixer. The mixture was then melt-mixed using a kneader (HAAKE™ Rheomix OS Lab Mixer equipped with banbury rotors) at a set temperature of 160° C. for 20 minutes. After cooling to room temperature, a mass of a melt-mixed material (i.e. isotropic intermediate composite material) was obtained in the kneader. The material was then crushed using a cutting-mill (equipped with a 0.5 mm cut-off sieve). The resulting lignin/Si mixture was then heat-treated, milled and classified according to Example 1, yielding a HC/Si composite material powder with 2.0 wt-% Si and with an average particle size of 10 µm.

### Example 6: HC/Si Composite Material Powder With 4.8 Wt-% Si, Obtained by Melt-Mixing with PEO

Softwood Kraft lignin was pre-mixed (dry mixed) with 2.0 wt.% Si particles (with a primary particle size of 200 nm) and 5 wt.% of PEO (Mw=1500 g/mol) using a laboratory mixer. The mixture was then melt-mixed using a kneader (HAAKE™ Rheomix OS Lab Mixer equipped with banbury rotors) at a set temperature of 160° C. for 20 minutes. After cooling to room temperature, a mass of a melt-mixed material (i.e. isotropic intermediate composite material) was obtained in the kneader. The material was then crushed using a cutting-mill (equipped with a 0.5 mm cut-off sieve). The resulting lignin/Si mixture was then heat-treated, milled and classified according to Example 1, yielding a HC/Si composite material powder with 4.8 wt-% Si and with an average particle size of 10 µm.

### Example 7: Pre-carbonized Intermediate C/Si Composite Material Powder Obtained by Melt-Mixing with TWEEN

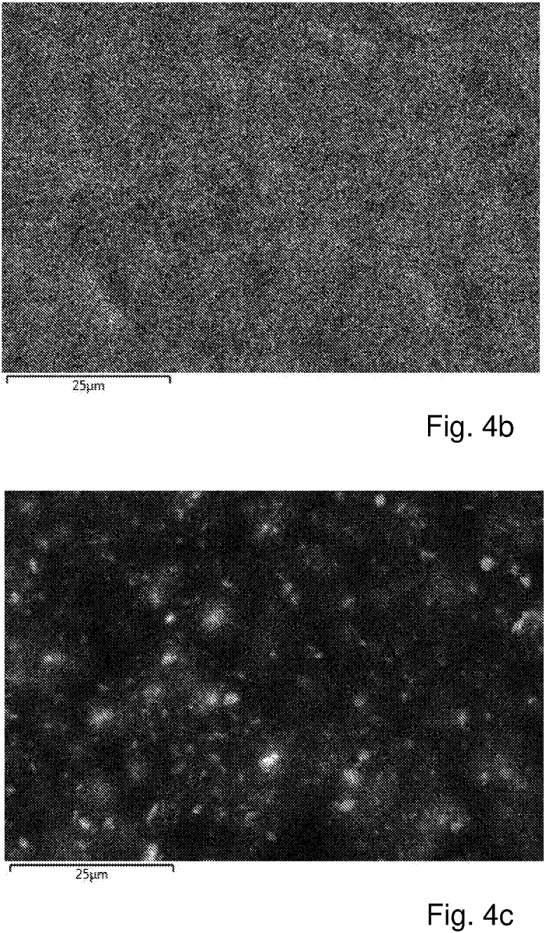

Softwood Kraft lignin was pre-mixed (dry mixed) together with 5 wt-% Si particles (primary particle size of 200 nm) in a laboratory mixer. The mixture was then melt-mixed using a kneader (HAAKE™ Rheomix OS Lab Mixer equipped with banbury rotors) at a set temperature of 160 ºC for 20 minutes, where 5 wt-% of TWEEN 80 was added directly after heating up in the kneader. After cooling to room temperature, a mass of a melt-mixed material (i.e. isotropic intermediate composite material) was obtained in the kneader. The material was then crushed using a cutting-mill (equipped with a 0.5 mm coarse cut-off sieve). The resulting lignin/Si mixture was then heat-treated by initial heating (but without carbonization) according to Example 1 and milled and classified according to Example 1, yielding a pre-carbonized intermediate C/Si composite material powder with an average particle size of 10 µm. FIGS. 4a-c are SEM (4a) and SEM-EDX (4b, carbon only), (4c, silicon only) images, respectively, of the obtained pre-carbonized intermediate C/Si composite material powder. It is evident from both SEM/SEM-EDX that Si is highly uniformly distributed.

### Example 8: Pre-carbonized Intermediate C/Si Composite Material Powder Obtained by Melt-Mixing with Teen

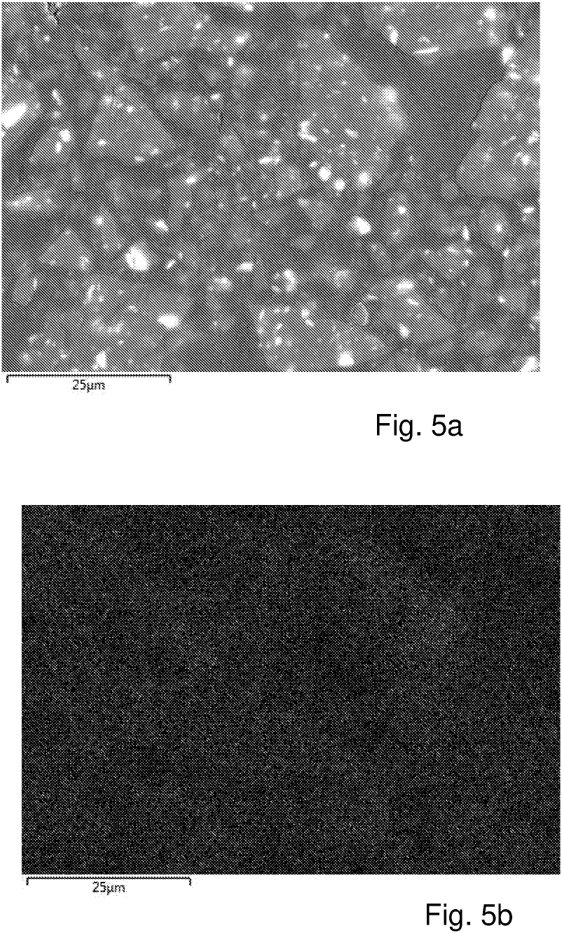

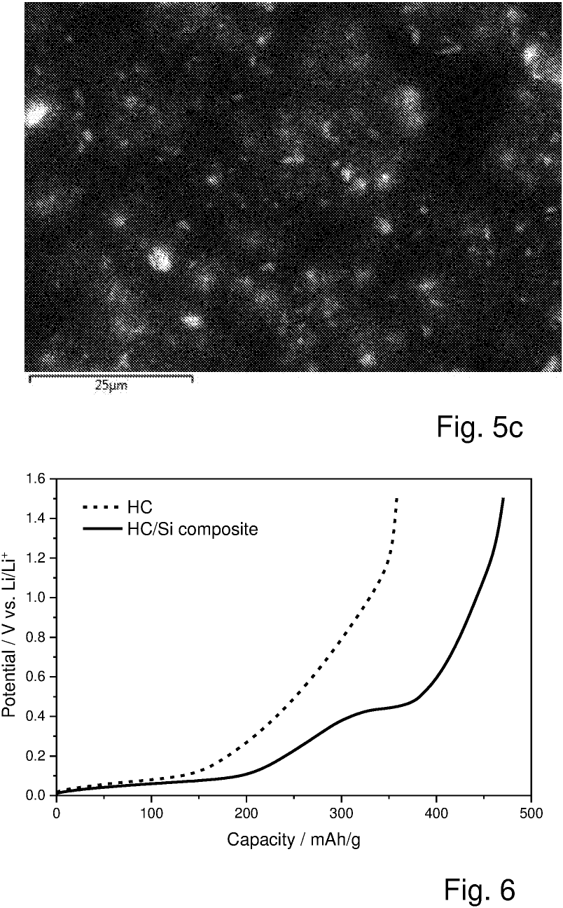

Softwood Kraft Lignin (90 g) was dispersed in water (1 liter), and TWEEN 80 (5 g) was added while mixing with a Ultraturrax mixer for 5 minutes at room temperature. In a next step, nano-silicon (200 nm) was added and mixing continued for another 5 minutes at room temperature. Subsequently, the mixture was filtered and dried at 80° C. in vacuum (10 mbar). Thereafter the sample was melt-mixed using a kneader (HAAKE™ Rheomix OS Lab Mixer equipped with banbury rotors) at a set temperature of 160° C. for 20 minutes and further treated as described in Example 7. FIGS. 5a-c are SEM (5a) and SEM-EDX (5b, carbon only), (5c, silicon only) images, respectively, of the obtained pre-carbonized intermediate C/Si composite material powder. It is evident from both SEM/SEM-EDX that Si is highly uniformly distributed.

### Example 9: Electrochemical Behavior of a HC/Si Composite Material Powder Obtained by Melt-Mixing

Electrodes were prepared from the HC/Si composite material powder of Example 6 or from pure HC of Example 1 and characterized electrochemically as follows: 82 wt-% HC/Si or HC were mixed with 8 wt-% poly(vinylidene fluoride) binder dissolved in 1-methyl-2-pyrrolidone, coated onto Cu foil via a doctor-blade process, and dried. Lab-type 3-electrode cells were built from the HC/Si or HC electrode, a Li metal counter electrode, and a Li metal reference electrode, using glass-fibre separators and 1 M LiPF₆ dissolved in ethylene carbonate : dimethyl carbonate (1:1 by wt.) as electrolyte. The cells were galvanostatically charged and discharged between 5 mV vs. Li/Li⁺ and 1.5 V vs. Li/Li⁺ using a specific current of 74.4 mA/g(AM), where g(AM) denotes the gram of active material in the electrode. FIG. 6 compares the discharge potential curves of the HC/Si and pure HC materials. By adding Si, the capacity could be increased by approx. 120 mAh/g. The presence of Si and its participation in the charge/discharge process is noticed by the prolongation of the potential plateau below 0.1 V vs. Li/Li⁺ and by the appearance of a second potential plateau between 0.4 and 0.5 V vs. Li/Li⁺.

In view of the above detailed description of the present invention, other modifications and variations will become apparent to those skilled in the art. However, it should be apparent that such other modifications and variations may be effected without departing from the spirit and scope of the invention.

1. A method for producing a carbon-silicon composite material powder comprising:
providing a carbon-containing precursor, wherein the carbon-containing precursor comprises lignin;
providing at least one silicon-containing active material;
melt-mixing at least two components to a melt-mixture, wherein said carbon-containing precursor constitutes one component and each silicon-containing active material constitutes one component, and wherein said melt-mixing is performed at a temperature between 120-250° C.;
providing said melt-mixture in a non-fibrous form and cooling said melt-mixture in said non-fibrous form so as to provide an isotropic intermediate composite material;
subjecting said isotropic intermediate composite material to a thermal treatment, wherein said thermal treatment comprises a carbonization step so as to provide a carbon-silicon composite material, and
subjecting said carbon-silicon composite material to pulverization so as to provide said carbon-silicon composite material powder.

2. The method according to claim 1, wherein the carbon-containing precursor comprises Kraft lignin.

3. The method according to claim 1, wherein the lignin is provided in particulate form.

4. The method according to claim 1, wherein the silicon-containing active material is selected from a group consisting of: elemental silicon, a silicon suboxide, a silicon-metal alloy, or a silicon-metal carbon alloy.

5. The method according to claim 1, wherein the silicon-containing active material is provided in particulate form.

6. The method according to claim 1, wherein the carbon-containing precursor is mixed with 0.5-30 wt-% of said at least one silicon-containing active material in the melt-mixing step.

7. The method according to claim 1, wherein the method further comprises a step of:
providing at least one dispersing additive and wherein the components melt-mixed in the melt-mixing step include said at least one dispersing additive.

8. The method according to claim 7, wherein said dispersing additive is selected from a group consisting of: monoethers, polyethers, mono-alcohols, polyalcohols, amines, polyamines, carbonates, polycarbonates, monoesters, polyesters, and polyether fatty acid esters.

9. The method according to claim 8, wherein said dispersing additive is selected from a group consisting of: polyethylene oxide and branched polyether fatty acid esters.

10. The method according to claim 7, wherein the carbon-containing precursor is mixed with 0.5-30 wt-% of said at least one silicon-containing active material and 0.5-10 wt-% of said dispersing additive in the melt-mixing step.

11. The method according to claim 1, wherein the method further comprises a step of:
providing graphite particles, or carbon particles, or both, wherein the components melt-mixed in the melt-mixing step include said graphite particles, or said carbon particles or both.

12. The method according to claim 1, wherein the melt-mixing is performed by kneading, compounding, or extrusion.

13. The method according to claim 1, wherein the method further comprises a step of:
pre-mixing at least two of said components to be melt-mixed before said melt-mixing step.

14. The method according to claim 13, wherein said pre-mixing is performed by dry mixing, dry milling, wet milling, melt-mixing, solution mixing, spray-coating, spray-drying, dispersion mixing, or combinations thereof.

15. The method according to claim 1, wherein said carbonization is performed at a temperature of 700-1300° C.

16. The method according to claim 1, wherein said thermal treatment further comprises one or more initial heating steps before said carbonization step, wherein each initial heating step is performed at a temperature of 250-700° C.

17. The method according to claim 16, wherein the method further comprises a pulverization step after said one or more initial heating steps and before said carbonization step.

18. The method according to claim 1, wherein the method further comprises a step of:
crushing or pulverization of said isotropic intermediate composite material before said thermal treatment.

19. The method according to claim 1, wherein said carbon-silicon composite material powder comprises powder particles having an average particle size between 5-25 µm.

20. The method according to claim 1, wherein said carbon-silicon composite material powder comprises powder particles, and
Wherein said method further comprises a step of:
carbon-coating the carbon-silicon composite material powder particles.

21. A carbon-silicon composite material powder obtained by the method according to claim 1.

22. A negative electrode for a non-aqueous secondary battery comprising:
the carbon-silicon composite material powder to claim 21.

23. (canceled)
